(19) United States
(12) Patent Application Publication
(10) Pub. No.: US 2011/0247058 A1
(43) Pub. Date: Oct. 6, 2011

(54) ON-DEMAND PERSONAL IDENTIFICATION METHOD

(76) Inventor: Friedrich Kisters, Kreuzlingen (CH)

(21) Appl. No.: 13/132,377

(22) PCT Filed: Dec. 1, 2009
(86) PCT No.: PCT/EP09/08533

§ 371 Date: Jun. 2, 2011

(30) Foreign Application Priority Data
Dec. 2, 2008 (AT) A 1868/2008

(51) Int. Cl. G06F 7/04

(52) U.S. Cl. 726/5

(57) ABSTRACT

The invention relates to a personal identification method based on requirements. An authentication checking system (1) thereby receives an authentication requirement (7) from a service provision system (5) and said requirement is analyzed and the required authentication level (9) is determined from the same. After activating (21) a detecting means (3) of a detecting device (2), a personal identifier is detected (22) and compared (23) to a corresponding reference feature (14) stored in a memory unit (15, 16). If the comparison matches, a release signal (17) is provided to the service provision system (5); if the match is incorrect (25) a further detecting means (3) of the detecting device (2) is activated and the corresponding process steps are repeated.

The invention relates to a query-based personal identification method.

In order to utilize an offered service, it is generally known that a person must correctly identify and authenticate him- or herself to the service provider. Especially when utilizing a service that is not local, the problem is that a correct and reliable authentication of the person requesting the service must be ensured across a distance. Especially during the utilization of a service, there is frequently the need for the use of the service itself or the additional services offered to be billed to the inquiring person. For that reason, it is particularly important that only a correctly identified person be able to utilize the services provided. For the correct authentication and/or identification of a person, it is known for a unique characteristic of the person to be detected and compared this to a reference characteristic. Furthermore, it is known to manage the use of a provided service via an access ID. Thus, an access ID and/or a unique user ID will be detected and if it corresponds to a reference characteristic, the service can be used.

The service provision system can now either manage and/or make available a plurality of different services, with different requirements also being available as to the quality and/or security of the authentication of a person. In order to access a news service, for example, this a lower security level is generally required than to access a financial transaction system. With known systems, a person had to run through a different authentication procedure for every different service, where the individual authentication procedures had to be completed mostly also on different detection devices.

Personal, individual identifiers also incorporate the risk, however, that they cannot be remembered if they are not regularly used and there is therefore the risk under certain circumstances that a correct and unique identification and/or authentication of a person is not always reliably possible.

A commonly used procedure therefore is the use of a few personal individual identifications, such as only a small number of passwords, as a result of which the security functionality of the identification and authentication check is circumvented. An attacker, using illicit deciphering to find out such password, could obtain access to a multitude of different services and therefore cause considerable damage.

If a personal identifier cannot be remembered because of too little use, for example, known systems provide virtually no possibility of using the desired service, because no emergency scenario is usually provided in order to obtain authentication nevertheless.

Moreover, known authentication methods are usually based on a correct reproduction of a pre-defined personal identifier and/or on the correct performance of a pre-defined sequence of actions by the person to be authenticated. In each case, this involves the correct reproduction of a predefined action, giving a potential attacker the ability to illicitly decipher these actions and therefore wrongfully access the service provision system.

Known methods are usually based on a so-called 3-factor authentication. For this purpose, personal authentication characteristics are used that essentially have a direct reference to the person. One of the disadvantages here is that these characteristics can sometimes be rather easily deciphered illicitly and therefore simply offer little security during the identification of a person. Known methods are usually also not sufficiently flexible to refer to different personal identifiers for the authentication of a person. Furthermore, in known methods, an incorrect detection of a personal identifier and/or an incorrect comparison usually result in stopping the authentication procedure.

The object of the invention therefore is to create a method for the unique identification and authentication of a person, with the authentication not being limited to a single personal characteristic and particularly eliminating the disadvantages of the prior art.

The object of the invention is attained using the method steps pursuant to Claim 1.

In a first step, the authentication checking system receives an authentication query from a service provision system. By transmitting the authentication query to an authentication checking system, the performance of the personal authentication and/or identification can be separated from providing the service, in particular a service provision system can therefore work together with multiple authentication checking systems, and/or an authentication checking system can receive an authentication query from several service provision systems. Another advantage is that only one authentication query will be transmitted, thus separating the performance of the personal identifier and/or authentication from performing the provision of the service. In particular it is therefore possible for the individual systems involved to be designed separately. The authentication query can therefore be designed flexibly such that, for example, not only an authentication query as such is transmitted, to which the authentication checking system responds, but that an inquiry with respect to the desired service is transmitted and thus based upon that the authentication checking system can activate a corresponding detection means.

In a further step, the authentication query is analyzed, and the necessary authentication level is determined therefrom. Due to the advantageous logical and/or physical separation of the service provision from the personal identification and/or authentication, it is possible to indicate the level of reliability to be attained when performing the authentication when transmitting query, in order to be able to permit the person access to the service provided. A preferred universally designed authentication checking system is therefore able to detect different personal identifiers, thus ensuring a different degree of authentication security by the method as taught by the invention. In particular, for noncritical services in terms of security relevance, a simply designed personal identifier can be recorded, and for highly critical services in terms of security relevance, a personal identifier can be recorded that is extremely difficult to decipher illicitly and/or to falsify.

After the required authentication level has been determined, an appropriate detection means of a detecting device is activated so as to thus capture a personal identifier which conforms at least to the required security level. The detecting device preferably includes several detection means in order to be able to record a plurality of different personal identifiers without the need for a further detecting device. In view of security-relevant concerns, this integrated detecting device has the very special advantage that it can be designed in a particularly secure fashion, thus attaining a high degree of security against falsification and/or manipulation. A further advantage is the independent detection of a personal identifier by the authentication checking system, and in particular by the detecting device.

The detected identification is subsequently compared to a corresponding reference characteristic stored in the memory unit; the memory unit can be arranged in the detecting device or in the authentication checking system. The comparison can thus be designed such that, apart from an exact comparison result, the degree of match is also determined, where, by appropriate parameterization, the degree of match required for a correct comparison result may be established.

If a match is determined, the authentication checking system outputs an enabling signal to the service provision system, whereupon the service provision system will make the requested service accessible for the person. This particularly assures the operator of the service that any usage fee that may be incurred can be unequivocally and unmistakably associated with a person. By an appropriate authentication level it can also be ensured that the person who utilizes a provided service performs a legally binding action, which can be documented unambiguously.

A particular advantage of the method as taught by the invention therefore is that, in the event of an incorrect match, a further detection means of the detecting device will be activated, and the method steps for detecting a personal identifier, as well as the comparison to a corresponding reference characteristic, can be repeated.

Due to external influences, it is possible for the subsequent comparison to fail during the detection of a personal identifier, even if no manipulation attempt has been made. In known methods, the authentication would be stopped in this case, and the person would therefore have no access to the requested service. With the method as taught by the invention, it is now advantageously possible to detect a further personal characteristic in order to repeat the failed authentication by a renewed authentication; in such a case, however a higher order personal identification in terms of security relevance must be performed this time. The determination of an authentication level establishes what minimum security the detected personal identifier must have in order to be able to utilize the service. With the method as taught by the invention, it now becomes advantageously possible, however, to detect the next-higher level of personal identifier in terms of security relevance in order to be able to perform the authentication for the required service. If necessary, the comparison operation can require a lower rate of overlap, since it is merely necessary to remediate a failed comparison of a lower authentication level in terms of security relevance. In a refinement of the invention, it is also possible for at least one other identifier to be detected that is equivalent in terms of security relevance instead of a higher-level personal identifier in terms of security relevance.

With the method as taught by the invention it is advantageously possible to remedy an inadvertently failed detection and/or an incorrect match in that a personal identifier, for example, a higher classification in terms of security relevance, is captured. In the event of an actual case of wrongful use, then this renewed authentication attempt will also fail, as a result of which the refinement has the advantage that, after multiple repeated incorrect matches, an alarm signal is output. To indicate that an error has occurred, this alarm signal can activate an alarm output device, for example, which is in communication with the authentication checking system and/or with the detecting device, and can therefore alert any monitoring personnel who may be present with respect to the attempted wrongful use. However, is also possible that such an alarm signal can be transmitted to the service provision system and/or to an alarm monitoring system, with the respective system initiating appropriate steps to prevent the attempted misuse and/or to alert a security service, for example.

This refinement in particular has the advantage that an erroneous incorrect authentication can be remedied, but a repeated, incorrect authentication can be recognized as attempted misuse.

A security code number that has a direct influence on the determination of the authentication level can be transmitted at the same time as the transmitted authentication query. A manipulation attempt in order to obtain authentication could consist of the authentication checking system being manipulated, for example, thus causing a higher authentication level to be replaced by a lower level, for example. With the claimed refinement it is now possible to specify a required authentication level from the service provision system, thus circumventing the determination step by the authentication checking system. In particular, it is therefore also possible to perform unanticipated security checks, for example, in that a security code number with a high-priority identification request in terms of security relevance is transmitted along with a low-priority authentication query in terms of security relevance in order to check the identity and/or authenticity of the requesting person at a higher level in terms of security relevance by random sampling. Even the misuse of a low-priority service in terms of security relevance over an extended period, and/or in the event of frequent utilization, can incur considerable damage, for example. Such manipulation attempts can also be detected by performing random security checks. With this refinement, it is particularly possible to determine an individually adapted security code number and therefore an individual authentication level for each authentication query. A random sequence generator can affect this security code number to such an extent, for example, that a virtually unforeseeable authentication query is transmitted and thus determines an authentication level which is clearly above that which is necessary for the requested service. The random sequence generator can also take into account the statistics of the past authentication processes, for example, and can demand a higher authentication level in terms of security relevance from a person with whom an increased occurrence of incorrect authentication attempts occurs more frequently.

For the authentication of a person, a personal identifier is captured, which must subsequently be compared to a reference characteristic. in order to increase the manipulation security, the authentication checking system can be designed such that a personal identifier is stored in a storage means only for the duration of the authentication procedure, in particular for the duration of the comparison procedure, and is immediately deleted thereafter.

Pursuant to the claimed refinement, a reference characteristic of a personal characteristic is transmitted with the authentication query and is therefore available for the comparison. However, this design also has the further advantage that the authentication checking system will be transmitted a personal reference identifier only when the person wants to identify him- or herself for the first time on this specific authentication checking system. For a distributed system in which a plurality of authentication checking systems are communicatively connected to one or several service provision systems, this has the particular advantage that the reference characteristics are transmitted only at the time of the authentication to be performed and that therefore the risk that stored reference characteristics could possibly be illicitly deciphered is substantially reduced.

If the authentication query is compared to a stored security hierarchy profile in order to determine the authentication level, this can be especially advantageous in that the authentication level is determined and/or assigned via the hierarchy profile, thus also allowing an individually adaptable assignment. In particular, this can be used to adapt the security hierarchy profile to the authentication checking system and, for example, in an environment in which an increased risk of manipulation of the authentication checking system exists, the hierarchy profile can be appropriately adapted, such that a fundamentally higher authentication level will be determined. This refinement has the further advantage that this security hierarchy model is individually adaptable and therefore an individual security hierarchy profile can be applied for each authentication query, for example. The security hierarchy profile can in particular be managed by the person him- or herself, for example, thus allowing an individualized authentication procedure to be created. It can also be determined by means of the security hierarchy profile what degree of match must be achieved during the comparison of the detected personal identifier to the reference characteristic. Furthermore, it can be determined how to proceed in the event of a negative match, particularly which personal identifier can be referred to in order to remedy the incorrect comparison.

According to a refinement of the invention, the security hierarchy profile establishes a correlation between the detection means of the detecting device and the authentication level. The authentication level is fundamentally used to determine which security-relevant requirement is required by the authentication to be performed, i.e., which minimum degree of security in view of a unique identification and/or authentication of a person must ensure the detected personal identifier. This refinement has the further advantage that individually designed authentication checking systems could exist, which potentially could also capture the personal identifiers differently, but due to the required and in particular universally valid authentication level, a correspondingly secure authentication of persons is assured.

With respect to safeguarding the authentication checking system against unauthorized manipulation, a refinement of the invention has the advantage according to which a procedural command is transmitted with the authentication query. As a result of this refinement, it can be guaranteed that a manipulation of the authentication checking system with respect to performing the detection of a personal identifier is made difficult and/or impossible, since the procedural command for performing the detection of the identifier is transmitted with the authentication query and the procedural command will therefore be transmitted again with each authentication query, if necessary. The authentication checking system can particularly be designed such that the information transmitted by the service provision system is stored only temporarily for the duration of the authentication process and will thereafter be permanently deleted. An attacker can therefore not access any potentially critical security-relevant information.

In another advantageous refinement of the invention, the authentication checking system controls the functionality of the detecting device, thus providing a further increase in the manipulation security. In most cases, the detecting device with the detection means is the first point of attack for an attempted manipulation, since this device, being the last link in the chain for performing the authentication of persons, is also open to access by unauthorized persons. If the control of the functionality of the detecting device is controlled by the authentication checking system, it will be made significantly more difficult for potential attackers to manipulate the comparison operation which follows the detection of the personal identifier.

With this refinement it is also possible to deploy standardized and thus universally usable detection devices, since the specific procedural command will be transmitted only with the authentication query and will subsequently be performed by the authentication checking system.

According to a refinement of the invention, an alphanumeric identification could be detected as a personal identifier. Such alphanumeric identification can be a combination of numbers, for example, a so-called PIN code, which can be entered via standardized and therefore widespread and inexpensive input means, such as by means of an alphanumeric keyboard. An input device is known, for example, from the field of automatic cash dispensing machines, such as an input device that has several selector keys as well as a numerical keypad. Expanded functionality and therefore an increased degree of security is offered by an input device, for example, into which letters also can be input in addition to numbers, as a result of which a so-called passphrase can also be input.

A personal identifier which must be recalled from the memory of the person and input via the input means in particular has the inherent risk that a potential attacker can watch the person during the input and therefore illicitly decipher the personal identifier. A significant increase in the authentication security will be achieved, if a biometric characteristic is captured as a personal identifier, since biometric characteristics can be uniquely correlated to one person, and the manipulation thereof is extremely difficult. The risk of immediate manipulation during the detection is also significantly reduced, since it is also possible to detect vital signs along with a biometric characteristic, for example, thus providing an extraordinarily high authentication security.

A further possibility for securely identifying and/or authenticating a person is for a sequence of actions which the person to be authenticated uses to operate the detection means is detected as the personal identifier. An operator action can be to input an alphanumeric identifier of the individual types in a certain specified sequence, for example. A further operational action could be, for example, the deliberate occurrence of one or several errors during the input of types, which can be remedied by operating a delete and/or correction function.

If, for example, a person is threatened and forced to input the personal identifier then this person can deliberately make or not make an error at predetermined positions of the identification; this deliberately incorrect operation will be perceived as a unique personal identifier, and will not only perform an authentication of a person, however, but also initiate an alarm action, for example, since the person has triggered this action by this deliberate erratic behavior. In the same way, a deliberately incorrect operation of the input means can be detected and interpreted as a personal identifier, for example, in that a confirmation function is triggered prior to the complete input of the alphanumeric identification. In each case, a person can initiate actions with the claimed development without a potential attacker would interpreting this apparently accidental incorrect operation as a personal identifier.

A refinement of the invention pursues a similar approach, according to which a chronological sequence of the operational actions will be captured during the detection of the personal identifier. As described again using the example of the detection of an alphanumeric identification, a person can input the individual types in a specific chronological sequence. For example, an longer pause between inputs may be provided at a certain point and/or the identification may be required to be specified within a certain maximum period of time. In a case in which a person is being threatened, the person can deliberately not adhere to the specified chronological sequence, in order to perform an apparently successful authentication, but can trigger an appropriate alarm action in the background. Also an attacker who has illicitly deciphered a personal identifier will not recognize the underlying chronological sequences, and a manipulation attempt would therefore fail.

In particular, using a personal identifier in combination with a plurality of different operational actions and/or different chronological sequences, it is possible to perform and/or initiate a multitude of potential authentication processes. It is possible, for example, for inputting an alphanumeric identification in combination with a corresponding operational action to initiate an automatic callback to a mobile communication device from the authentication checking system, which must be responded to in a well-defined manner by the person to be authenticated. If the response to the callback does not occur in the specified manner, for example, if the person does not accept the callback, although the authentication can appear to have been performed successfully, for example, while an appropriate alarm action is triggered in the background.

By means of a position locator in the mobile communication device, the location of the person in question may be determined by the authentication device, so that the person can be provided with specific help. If necessary, provision can also be made for the detecting device to also have a short-range communication device, so that the user must be located within a well-definable and particularly small distance in order to successfully authenticate him- or herself with the mobile communication device, which has a corresponding communication terminal.

The previously described personal identifiers are all based upon a deliberate action by the person to be authenticated. Besides that, there is still the further possibility of detecting an unconscious behavior of a person as a personal identifier, in that the detection device outputs a personalized inquiry by means of an input/output device and subsequently captures the response reaction of the person. Such reactions can hardly be manipulated, because they are based upon an unconscious reaction model of the person, which cannot be illicitly deciphered by a potential attacker, because the reaction model would already be falsified in most cases as a result thereof. The detecting device can output an input request, for example, and offer several choices. Independent of the currently presented input request, the person will always have the same intuitive reaction to a specific category of input requests, which represents a high degree of authentication in terms of security relevance. The input request presented will preferably be selected from an inventory of a plurality of potentially different input queries.

A significant increase in authentication security is obtained if the security hierarchy model is transmitted from an authentication system to the authentication checking system, since this will achieve a separation of the authentication from the provision of a service to be utilized. A particular advantage is that the authentication system can be arranged within a highly secure area, for example, while in most cases lower security requirements are necessary for a service provision system. This will therefore particularly prevent access to the authentication checking system from being achieved by manipulation of a service provision system, for example, in order to use it to obtain access for a wrongful purpose to another higher-order service provision system in terms of security relevance.

In view of adapting the method as taught by the invention as individually as possible to the individual personal identifiers as well as to the individual behavior patterns, an advantageous refinement of the invention proposes creating the security hierarchy profile during a training phase, with personal identifiers being recorded as reference characteristics and stored in a storage means. This storage means will preferably be arranged in the authentication system, though arrangement in the service provision system is also possible. The capturing of personal identifiers during a training phase has a further advantage in that the connecting device used for that purpose can be arranged in a particularly protected environment in terms of security relevance, and/or that an appropriate legal environment can furthermore be created, in order to be able to design the recorded identifications to also be legally binding. During the training phase it is particularly important that the identity of the person be uniquely determined and that the captured identifications can therefore be unambiguously correlated with this person.

This authentication can be done by means of an identity document which is presented to a legal authority such as a notary, for example, who will verify the document by means of a checking device such as a passport reader for validity and will subsequently record personal identifiers and store them in a legally binding fashion in a storage means. The reference characteristics thus recorded can now be stored in the authentication checking system during the production thereof, but it is also possible to store them in an external storage module which will be arranged in an integrated fashion along with the authentication checking system. The reference characteristics can also be transmitted via a communication link to the authentication checking system.

In order to expand the possibilities for authentication of persons and/or in order to increase the security of such authentication, it is advantageous for a conscious behavior pattern to be recorded as a personal reference characteristic, in that a specific sequence of operational actions is captured on the detecting device. For an alphanumeric identification, the possibility exists, for example, of specifying the identification in a predetermined sequence; however, it is also possible to input the identification in a reverse or different manner and to indicate by means of an intentional keying error in order to consequently be able to trigger a specific behavior.

The combination of a personal identifier that is weak in terms of security relevance with a conscious behavior pattern as a personal identifier can achieve a significant increase in authentication security. In particular, limited functions of the authentication checking system can also be defined in this manner in order to be able to trigger security measures during an attempted misuse.

Likewise, an unconscious behavior pattern can be recorded as a personal reference characteristic, in that the person is presented with multiple choices by means of an input/output device, and the respective selection made is detected. For this purpose, the choices are preferably selected from an inventory of simple situational characteristic descriptions and will be presented to the user on an indicating device and the reaction recorded by means of a keyboard and/or an input means. The choice is designed such that a unique and indubitable selection is ensured.

It is especially advantageous if a reaction profile is created from the captured selection results since, based upon this reaction profile, it is possible to determine the user's reaction to a specific choice, when this choice is presented to the user during the subsequent authentication for utilizing a service. In particular, it is essentially impossible to manipulate unconscious behavior patterns of this kind, an especially high security level can be achieved by using the detection of an unconscious behavior pattern as a personal identifier. This refinement also has the particular advantage that a potential attacker essentially cannot detect such a reaction profile by means of illicit deciphering.

According to a refinement of the invention, reference characteristics are stored in the memory unit of the authentication checking system, which has the advantage that it can be operated without a connection to a central authentication system and can therefore perform a unique and reliable personal authentication entirely autonomously. This development is particularly advantageous if a reliable personal authentication is required for a so-called single-user system in which the service provision system and the personal authentication system are co-located and no communicative link with a remote system is needed.

With this refinement, particularly so-called “standalone” systems can be designed, which offer adequate access protection as a result of appropriate mechanical security and/or protection measures, for example, as well as a high degree of authentication security due to the high security against manipulation.

According to an advantageous refinement of the invention, an authentication query is generated on the service provision system or on the authentication checking system at the end of a timer sequence, since therefore a repeated authentication can be specifically triggered. After a successful authentication, a user can utilize the provided service, in particular until logging off from the service provision system and/or from the authentication checking system. With increasing time of usage, the risk of manipulation by unauthorized third parties increases, however. Particularly the degree of reliable authenticity of the logged-on user, when plotted against time of use, decreases significantly, usually even in a nonlinear fashion. It can thus be ensured with the development that a repeated authentication will be required from the user at regular and/or optionally specifiable time intervals, preventing circumstances under which a user is logged on to the service provision system for an extended period. The authentication query according to the Claims can be transmitted only from the service provision system and therefore corresponds to a query as it arrives for the initial authentication pursuant to the process steps as taught by the invention. Furthermore, however, the authentication query can also originate from the authentication checking system itself, at which point the query is processed immediately as if it had arrived from the service provision system. A repeated authentication query by the authentication checking system has the advantage, for example, that this system can take into account the locally prevailing security environment and, in an unsecured environment, for example, permits only a short validity period for authentication, without this needing to be specifically stored in the service provision system.

Moreover, according to a refinement of the invention, an image of the person can also be captured as a personal identifier. In this manner, an optical, visual comparison is possible, for example; in particular, unique and/or characteristic features can be determined from the captured image by means of known image analysis methods.

Images that were captured according to an internationally recognized standard, such as that of the ICAO (International Civil Aviation Organization), can be prepared in an unambiguously analytical fashion and can therefore be compared to a reference characteristic with a high reliability factor.

A further factor for increasing the authentication security is obtained if the captured image is transmitted to a mobile communication device. A group of people can be individually defined for each user, for example, if the members of said group are willing to perform an optical visual authentication of a person and to verify the authenticity thereof. Automatic authentication systems perform the authentication of a person according to strictly defined rules; an individual investigation of the environment and/or the situation will not be done. Using this refinement now introduces a human evaluation factor; in particular, it is possible to evaluate the situation in which the authentication query occurs. A person can be forced to perform the authentication, for example, and would thus potentially input a correct personal identifier. With the refinement according to the Claims, the image is transmitted to a mobile communication device by means of a data service such as MMS, whereupon the recipient can recognize that the person is threatened and can therefore subsequently initiate measures for the protection of the threatened person. By including a network of individuals, a significant increase in the authentication security will be achieved, since each individual of this network, both as an authenticating entity as well as one that is to be authenticated, aims for high security and will therefore pay special attention to reliable performance of authentication. Such authentication method can be handled and/or accounted for by a bonus system, for example.

For the purpose of a better understanding of the invention, it will be explained in detail with reference to the following Figures.

The highly simplified schematic representations show respectively:

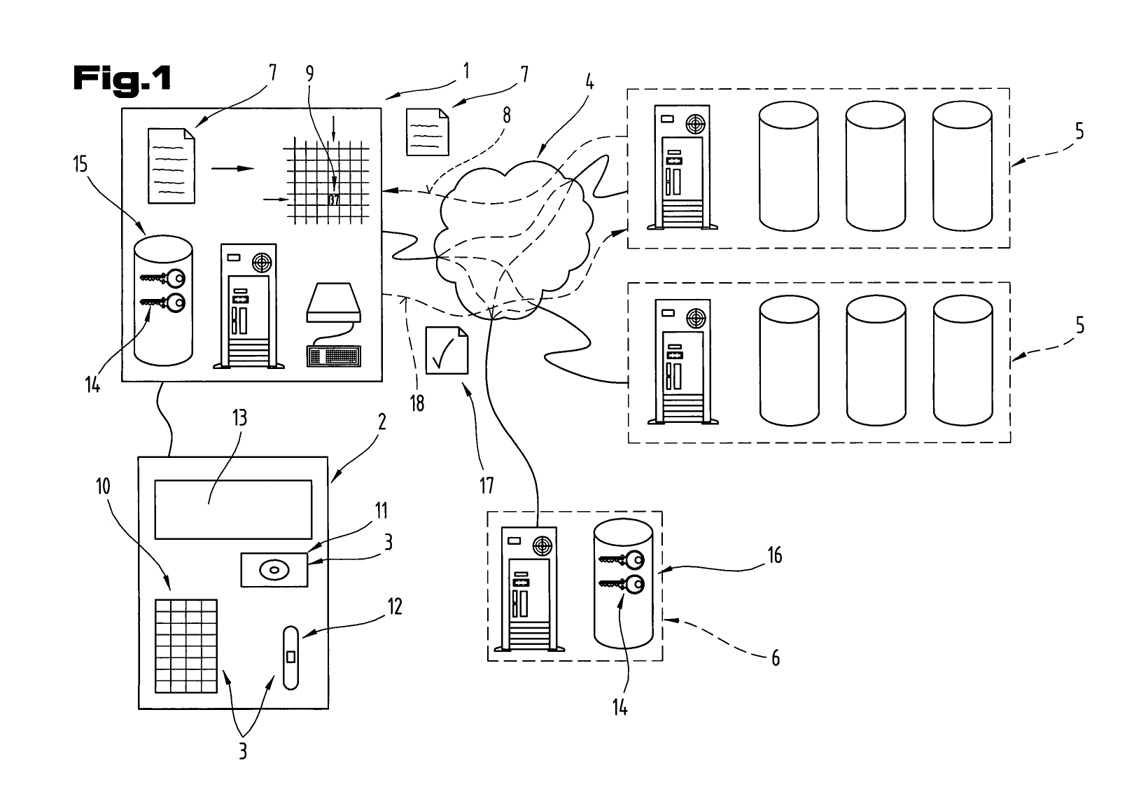

FIG. 1 the method as taught by the invention by means of an exemplary device;

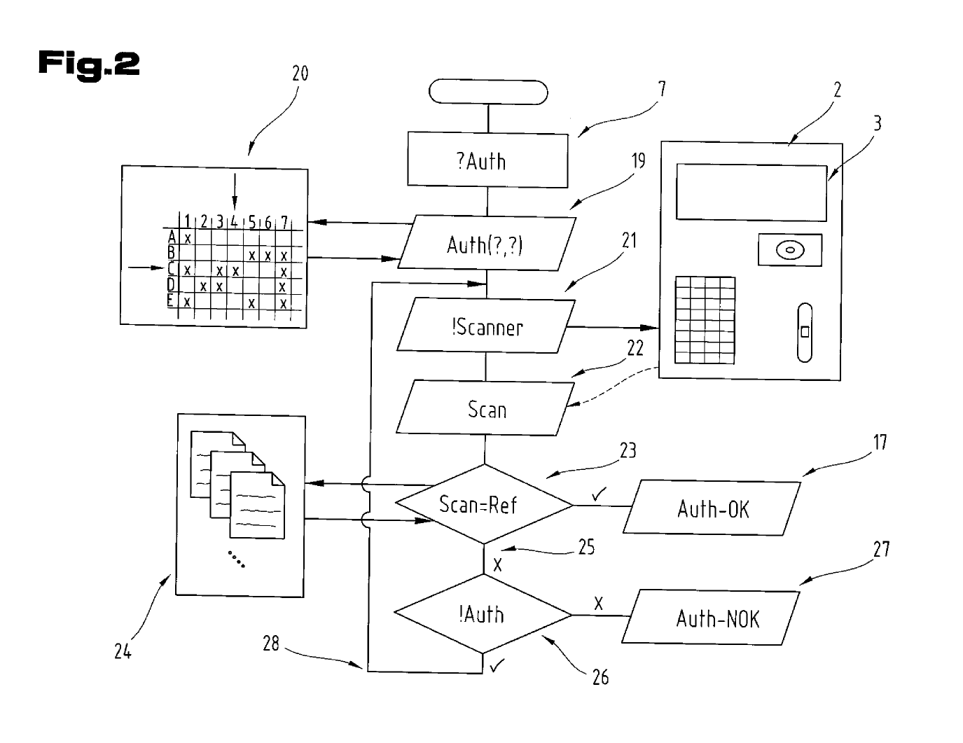

FIG. 2 a flowchart of the method as taught by the invention;

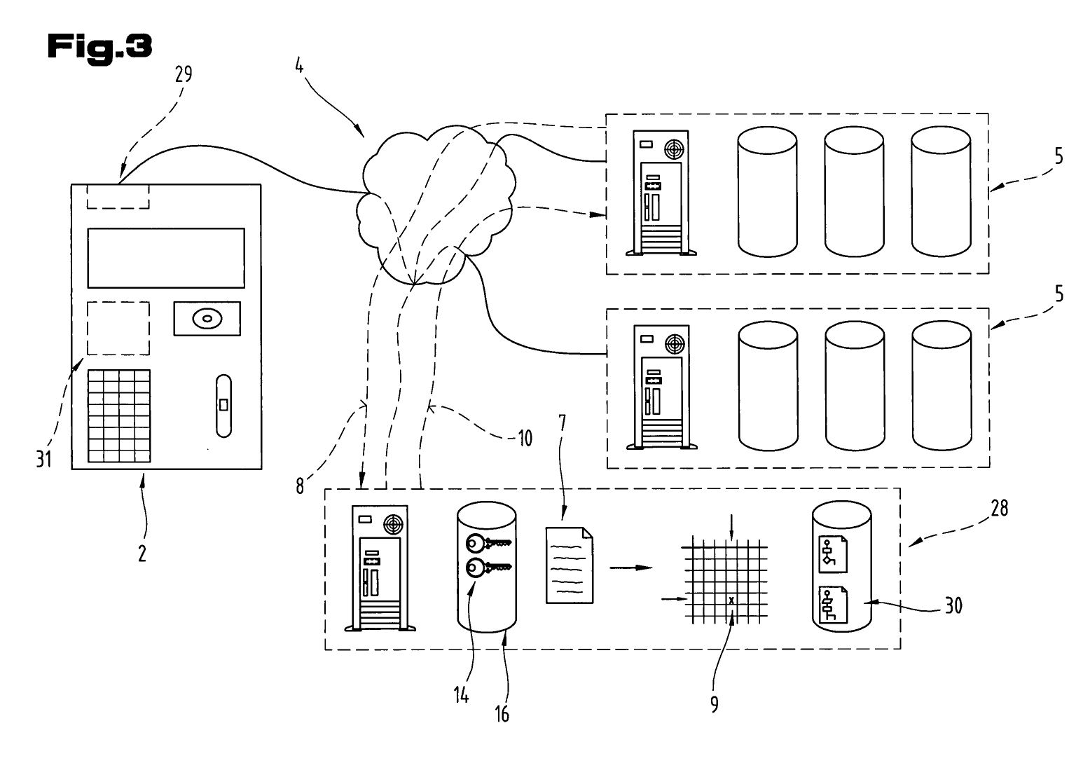

FIG. 3 shows a further potential system for performing the method as taught by the invention.

It should be noted at the outset that the same parts described in the different embodiments will be denoted with identical reference symbols and/or identical component descriptions; the disclosures contained in the entire description apply mutatis mutandis to identical reference symbols and/or identical component descriptions. Also, the information selected in the description related to position, such as top, bottom, sides, etc. are related to the figure depicted that is being currently described, and must be transferred mutatis mutandis to the new position, if the position is changed. Furthermore, individual characteristics or combinations of characteristics from the different embodiments shown and described can also represent independent inventive solutions, or solutions of the invention, per se.

All information provided relating to ranges of values in the description of the subject matter are to be understood to also include any and all sub-ranges thereof, for example, the statement 1 to 10 is to be understood so that all sub-ranges, starting from the lower limit 1 to the upper limit 10 are included, i.e. all sub-ranges beginning with a lower limit of 1 or bigger and end with an upper limit of 10 or less, e.g. 1 to 1.7, or 3.2 to 8.1, or 5.5 to 10.

FIG. 1 illustrates the process steps as taught by the invention by means of an exemplary device for performing the process. This device includes at least one authentication checking system 1, which is in communication with a detecting device 2 and where the detecting device 2 has several detection means 3. The authentication checking system 1 is connected via a communication network 4 to at least one service provision system 5; an authentication system 6 is optionally present that is in communication with the authentication checking system 1 and/or the service provision system 5.

The method as taught by the invention is used particularly for the purpose of guaranteeing for a service requested from a service provider that the user who has requested the service can be authenticated and identified unequivocally and unmistakably.

With the method as taught by the invention, it is furthermore possible to provide an individually specifiable authentication of a person with respect to the detection security. This is particularly important because the service can be a financial transaction, for example, or may also include legally binding processes. The user will therefore initiate a corresponding process at the service provider; the service query is not the subject matter of the invention and will therefore not be further discussed here. As an example, such a service query could be initiated in that a user performs an operational action on a query device that can be a part of or an addition to the detecting device 2, which is transmitted to a service provision system 5 and initiates the corresponding processes thereon. In view of the reliability of the authentication of a person, the first priority should be to always work at the maximum security level. Since personal characteristics to achieve this security level can be complex and sometimes difficult to detect, it is especially advantageous for the characteristics to be detected to be adapted to the required security level for the requested service, thus requiring less pronounced personal identifiers for noncritical services in terms of security relevance. The method as taught by the invention now offers the possibility of providing different authentication levels in an integrated fashion and a remediation of defects in the event of an incorrect comparison check.

In a first step of the method as taught by the invention, the service provision system 5 transmits an authentication query 7 to the authentication checking system 1. By an analysis of the transmitted authentication query 7, the authentication checking system 1 determines a required authentication level 9. This authentication level specifies which level of detection security the personal identifier to be detected must have in order to be permitted to utilize the requested service. In particular, the authentication level 9 therefore determines which detection means 3 of the detecting device 2 must be activated in the next process step as taught by the invention to detect a personal identifier. For a service with a low security relevance, a personal identifier can be detected as an alphanumeric identifier, for example, that is input via an alphanumeric input means 10, such as a keyboard. For higher order services in terms of security relevance, biometric characteristics can be detected, for example, an image of the face of the person or an image of the iris can be detected by means of an optical image acquisition device 11, and with a so-called fingerprint scanner 12, the finger minutiae can furthermore be detected.

The detecting device 2 can also have an audiovisual input/output device 13, in order to be able to detect an unconscious and/or a conscious user behavior as a personal identifier.

The detected user identifier will be compared to one or more corresponding reference characteristics; this corresponding reference characteristic 14 can be arranged in a storage means 15 of the authentication checking system 1. The reference characteristic 14 can also be arranged in a storage means 16 of the authentication system 6, however; this design has the advantage that the authentication system 6 can be designed in a particularly secure and/or particularly protected fashion and therefore offers very high security against manipulation. The arrangement of reference characteristics 14 in the storage means 15 of the authentication checking system 1 has the advantage that the authentication checking system can perform the comparison of the detected identifier with the reference characteristic itself, and therefore the authentication and/or identification of a person is possible without additional systems.

The comparison of the detected identifier with the corresponding reference characteristic would be successful in most cases; in such a case, the authentication checking system 1 will output 18 a release signal 17 to the service provision system 5.

The essential difference between the method as taught by the invention and the known methods is also based upon the further steps that are performed if the comparison of the detected identifier with the corresponding reference characteristic fails. In known methods, the authentication is stopped in such a case and the user is denied access to the service provision system 5. In order to authenticate him- or herself again, the user would therefore have to initiate a new service query 7. In contrast, the method as taught by the invention has the particular advantage that, in the event of an incorrect comparison, a further detection means 3 of the detecting device 2 will be activated automatically in order to repeat the corresponding process steps as taught by the invention and in particular detect a further personal identifier.

Since an authentication level 9 was determined from the transmitted authentication query 7, the necessary reliability of the captured personal identifier is thus determined as well. Because of statistically independent events, it is possible for the comparison to fail without a manipulation attempt being involved. The method as taught by the invention now provides, for example, for a personal identifier to be captured with one characteristic, or with several additional characteristics, or at the next highest security level, in order to rectify the failed comparison in this manner. During the input of an alphanumeric identifier, an unintentional keying error can occur, for example, as a result of which the subsequent comparison will fail. In a refinement of the invention, the user could be requested to input the identifier again. However, the invention teaches that provision may in particular be made for a further detection means 3 of the detecting device 2 to be activated by the authentication checking system 1 and for the appropriate process steps to subsequently be performed again.

Therefore, by detecting a higher order personal identifier, i.e., an identifier with a higher authentication level 9, it is possible to rectify an incorrect comparison of a captured lower order personal identifier; it is particularly advantageous for the match criteria of the comparison to be individually adaptable so that a higher order personal identifier must have a lower degree of match to rectify an unsatisfactory comparison of a lower order personal identifier than would be necessary for a corresponding comparison operation of the higher authentication level. Several lower order identifiers together could also replace a higher order identifier, if their total is equivalent to the higher order identifier in terms of security relevance, which is something that can be determined in advance. The method as taught by the invention can now in particular repeat the capture of a personal identifier as often as higher authentication levels in terms of security relevance are available. If the comparison of a personal identifier to a stored reference characteristic fails repeatedly, an alarm signal in the form of an error identification signal will be output by the authentication checking system 1. This alarm signal can be transmitted to the service provision system 5, for example; however, it can also be transmitted to an alarm monitoring system, if available, and/or to the authentication system 6.

This alarm signal can now be evaluated by stopping the currently running personal authentication and sending an alarm to a security monitoring device, for example, which initiates appropriate security measures, such as alerting the respective security personnel. However, the alarm signal can also be evaluated in such a way that the authentication query appears to have been successful, thus misleading a potential attacker to believe that the manipulation attempt was successful, while appropriate alarm and/or security measures are already being instituted in the background.

FIG. 2 shows a simplified representation of the process flow of the method as taught by the invention. An authentication query 7 is transmitted from a service provision system 5 to the authentication checking system 1. This authentication query 7 includes an identifier of the querying service provision system 5, for example, and in particular has an identifier which allows the corresponding authentication level 9 to be determined. During the process step of determining the authentication level 19, the authentication query 7 is analyzed and/or processed such that the corresponding authentication level 9 is determined by comparing the authentication query to a stored security hierarchy profile 20, for example. The authentication query 7 is preferably designed nonspecifically, so that the method as taught by the invention can be used as universally as possible, and therefore transmits only a generic service description and/or security query. The specific implementation of the necessary security level of the authentication query 7 is preferably performed by the authentication checking system 1, particularly in that the relationship is created in which a personal identifier must be detected by the detecting device 2 in order to achieve at least the authentication level 9 determined by the security hierarchy profile 20.

After the authentication level 9 has been determined 19, a detection means 3 of the detecting device 2 is activated in the next method step 21, where the determination is made based on the authentication level which detection means must be activated in order to be able to capture a personal identifier with the respective security level and/or reliability. Here, one of the essential advantages of the method as taught by the invention is already apparent as the process for performing the method as taught by the invention is designed with a device which can detect personal identifiers such that variable degrees of security levels can be achieved.

In a further process step 22, the activated detection means 3 of the detection device 2 detects a personal identifier, which is compared to a stored corresponding reference characteristic 24 in a subsequent comparison step 23. The reference characteristic 24, but in particular a plurality of reference characteristics, is filed in a storage means which is preferably arranged in the authentication checking system 1. The memory with the reference characteristics can also be arranged in an external authentication system, however. This reference characteristic 24 represents a code to enable access to a service provision system, for example. For this reason, it is particularly important that the access to these reference characteristics be secured so as to prevent manipulation to the maximum extent and thus reliably show the authenticity of the reference characteristics, which is particularly very important for the comparison 23.

If the comparison 23 of the detected personal identifier to the stored reference characteristic was successful, then a so-called release signal 17 is transmitted to the requesting service provision system, whereupon the system, based upon the determined identity and authenticity of the person, can provide the requested service. If the comparison fails, then the personal identifier therefore does not correspond 25 with the reference characteristic; compared to known methods, it is now possible to initiate a renewed authentication sequence with the method as taught by the invention. For this purpose, a comparison operation 26 will determine whether the authentication detected permits a renewed sequence of the authentication steps to be performed. If an authenticity level was determined that was high in terms of security relevance, for example, then an incorrect comparison cannot be remedied by a higher order authenticity level in terms of security relevance, for example. In this case provision may be made to capture the personal identifier again and also to perform the comparison again, or add up several lower order identifiers in terms of security relevance. If another incorrect comparison occurs, an error signal 27 may be output and the authentication of the person has therefore failed.

Along with the authentication query 7, a security code number can be transmitted which flows directly into the authentication code number 9. The authentication code number can moreover be determined by a correlation table, in which a correlation between a service provision system and/or a category of service provision systems and a corresponding authentication level is created. However, the security hierarchy profile 20 allows a significantly finer graduation in the authentication level and the process sequence determined thereby. For an authentication level, for example, A to E, several options can now be determined, which determine the requirements during the detection of the personal identifier on the one hand, and on the other the behavior of the method as taught by the invention during a failed comparison of the detected identifier with the stored reference characteristic. In this way, it is possible to determine, for example, which detection means of the detecting device are required to reach a specific authentication level. A personal identifier can therefore be detected with a specific detection means, for example, and as a result will meet the necessary security requirements. However, it is also possible for one or several detection means to be combined with a lower detection security in terms of security relevance, for example, in order to achieve the necessary detection security. As already mentioned previously, it is also possible to detect a higher order personal identifier in terms of security relevance in order to guarantee the required authentication level. It is also possible to determine via the security hierarchy profile 20 how precisely the match of the personal identifier with the reference characteristic must be performed during the comparison 23 and/or which minimum degree of match must be attained. It can also be determined via the security hierarchy profile 20 which detection means of the detecting device is permissible for which authentication level, and for which authentication level a renewed authentication is permitted.

The method as taught by the invention therefore represents an expansion of the known 3-factor authentication method. These methods utilize and/or use a personal identifier for the following categories of characteristics, for example:

What I am: a unique characteristic of the person: physical characteristics such as voice, fingerprint, iris, palm of the hand, face;

What I know: a characteristic that only the person knows: a reference number/password and/or a passphrase; personal information and preferences;

What I have: a characteristic that belongs to the person: a key card or a token, in particular any device that is designed for storing a key characteristic or which itself is a key characteristic; a bank and/or credit card, or a form of identification.

Known methods for authentication of a person are mostly based upon checking a characteristic by comparing it to a stored reference characteristic. In case of an incorrect comparison, the authentication process is normally repeated, whereas the authentication process is stopped in case of repeated incorrect comparisons, thus denying the user access to the requested service. The detecting devices for performing the known authentication processes are moreover mostly designed such that only one characteristic and/or one characteristic category can be detected; a replacement and/or a change of characteristics and/or characteristic categories is not possible in most cases.

In addition to the three known factors and/or characteristic categories, the method as taught by the invention now offers two additional categories, which can be detected as an independent personal identifier and/or are used in combination with one or more characteristics of the known categories. A new category of characteristics, as is applied in the method as taught by the invention, is characterized by the conscious behavior of the person during the presentation and/or input of a characteristic. As already mentioned previously, a conscious action and/or a conscious behavior can consist in inserting intervals and interruptions into the detection process and/or making deliberate keying errors, or changing the sequence of inputs by using a skip function during the input of the identifier, for example. Consequently, the correct input of a personal identification (PIN) can be characterized, for example, in that a keying error with a subsequent correction is precisely what is intended. If a person is threatened, that person can input the identifier without errors, for example, which is clearly recognized by the authentication checking system as an alarm signal because of the stored security hierarchy profile. This conscious behavior during the detection of a personal identifier rather significantly expands the achievable security levels of the known three factors and/or characteristic categories for the authentication of a person.

Particularly the detection of a conscious behavior is especially advantageous, in that it is essentially impossible for a potential attacker to illicitly decipher such a personal identifier, since such a behavior and/or action can only be distinguished with difficulty from a person's normal behavior. A potential attacker would interpret a keying error as a coincidence, for example, and would therefore not recognize that this apparently accidental keying error is part of a personal identifier. It would also be possible for the user to activate several types of keying errors so that each of them would have been stored in the authentication process as being valid and could be input alternatively or combined by the user.

In particular, the user can determine independently via a configuration tool, for example, which types of personal identifiers will be presented in groups on the detecting device (2) as options. The user can furthermore determine a correlation between one or several service provision systems and such an authentication group, so that the user is offered several of such groups during the authentication, for example, with only one authentication being valid and/or approved with the required service. Therefore, by determining an initial login profile of this type, it is possible to create yet another personal identifier, since in case of a threat, the user can intentionally select the incorrect group, thus initiating the alarm and/or security measures again, for example.

In addition to a conscious behavior as a characteristic category for authentication of a person, the method as taught by the invention offers another category of characteristics, which can also be used to refer to an unconscious behavior of the person for the authentication thereof. While the characteristics of the known three categories may be illicitly deciphers and, optionally, reproduced, and this is also possible for the fourth category under very specific circumstances, this is almost impossible with an unconscious behavior, because such a behavior pattern is inherently very specific for each person and which would therefore be falsified by an attempt of manipulation. Such unconscious behavior pattern can be determined during a training phase in that the reaction and/or the behavior of the person in response to a plurality of standardized questions and/or choices, in particular based upon psychological principles, is detected. A plurality of different testing and/or evaluation methods for the creation of a personal behavior pattern are known from the special field of behavior research; they will not be discussed in further detail here.

In particular, a person can be authenticated by his or her behavior; this fundamental behavior is deeply anchored in the person's subconscious, thus providing an extraordinarily high degree of authentication security.

One category of personal identifiers can also lie in the fact that the type of the selected authentication category, controlled by the security hierarchy profile, for example, can be referred to as a personal identifier. For example, the authentication checking system can also specify an incorrect authentication category and/or authentication level for the required service from the user, such as in which the identifier for a lower order in terms of security relevance is to be detected for requesting a financial transaction service. In order for the authentication to be correct, the person would have to stop and reinitiate the authentication process, or refuse the specified authentication category and request a new and particularly higher order category in terms of security relevance.

Furthermore, with a grouping of users, an additional hierarchy level can be introduced, where a user has the choice to join a group and/or withdraw from it. Such type of grouping can now be designed such that specific characteristics are stored for each group, which are known to the individual user. This grouping is preferably carried out such that the individual group members essentially know each other and therefore also know the specific personal details, which are not available to a potential attacker in any case. A group-related identifier could be, for example, requiring the authenticating user to indicate the identifier of a mobile communication device of a user of the group.

The method as taught by the invention now offers a significant increase of the individually adaptable security level during the authentication of a person, in particular in view of the possibility of the actions that can be triggered, without having to specify a multitude of different personal identifiers for that purpose. The larger the number of different personal identifiers a person must remember, the larger the risk that the potential multitude will be ignored and that only a few personal identifiers will be used.

It is therefore relatively easy for a potential attacker to illicitly decipher these identifiers and thus gain access to a multitude of different services. But with the method as taught by the invention it is possible to use a small number of personal identifiers in combination with the further authentication and/or characteristics categories and to obtain a very substantial increase in identification security and, at the same time, also provide the opportunity to minimize the intentional sounding out of personal identifiers by third parties.

The very substantial advantage of the method as taught by the invention is thus based upon the fact that a person can be authenticated by the detection of personal identifiers that essentially cannot be illicitly deciphered by a potential attacker. A threatened person furthermore has the ability to consciously make the wrong selection and/or input, without the attacker being aware thereof, in order to initiate security measures in this way, if necessary. A very substantial advantage furthermore is that the authentication based upon the detection of personal identifiers is designed to be sufficiently flexible that the required security level of the authentication is possible not only by the detection of a provided personal identifier, but that also personal identifiers of a higher order in terms of security relevance and/or several lower order personal identifiers in terms of security relevance can be referred to. In order to circumvent the authentication method as taught by the invention, a potential attacker would therefore have to illicitly decipher a plurality of different identifiers, which is highly unlikely and is normally in no relation to the benefit and/or to the risk associated with the discovery of a manipulation attempt.

This method furthermore allows authentications to be performed, the security level of which varies within the same environment, for example, in an establishment with a POS (Point of Sale) unit. In order to conduct a low-volume transaction and/or one which has a low monetary value, the detection of a lower order personal identifier is sufficient in terms of security relevance. In contrast, the detection of a higher order personal identifier in terms of security relevance can be required for a large transaction volume and/or for one which has high monetary value. The rules for such determination of the security levels can be stored in the service provision system and/or in the authentication checking system. These security levels can moreover be combined with further rules as taught by the invention; furthermore, a random sequence generator can be present with which random samples are taken optionally, in which a user must identify him- or herself with a higher security level than would be necessary for the required service.

It is therefore quite possible for the same user to be required to follow two different authentication procedures during the completion of the same transaction in the same establishment.

FIG. 3 shows an additional possible device for performing the method as taught by the invention. Here, the authentication checking system and the authentication system are integrated into one authentication control system 28, which therefore includes all essential devices in terms of security relevance for performing the method as taught by the invention. In particular, this device ensures that no data in terms of security relevance, such as reference characteristics, for example, are stored in the detecting device 2 and that furthermore the comparison check can be performed in an especially secure authentication control system 28. The detecting device 2 has a communication interface 29 for this purpose, via which a communication link with the authentication control system 28 can be created. To perform the detection of the personal identifier, provision may be made, for example, for control commands stored by the authentication control system 28 to be transmitted to the detecting device 2 and stored temporarily there in an execution module 31 from which they are executed in order to control the detection means of the detecting device 2. The execution module 31 can be designed such, for example, that it performs a signature check of the transmitted control commands 30, as a result of which a deliberate manipulation of the detecting device by importing an incorrectly marked control command is prevented to the greatest possible extent.

This design particularly has the advantage that very simple technical and thus cost-effective detecting devices 2 can be used, since control of the sequence as well as the comparison operation of the detected personal identifier to stored reference characteristics 14 is performed by a central authentication control system 28, and the detecting device therefore has no components which are essential in terms of security relevance and can be manipulated.

In this design, the authentication query will be transmitted from the service provision system 5 to the authentication control system 28.

The authentication control system will subsequently perform the process steps as taught by the invention and, upon a successful authentication of a person, transmits a release signal to the querying service provision system 5.

The exemplary embodiments show possible embodiment variants of the query-based personal identification method; it should be noted at this point that the invention is not limited to the specifically illustrated embodiment variants thereof, but rather various combinations of the individual embodiment variants with one another are also possible and this variation ability based upon the teaching for the technical action by the subject invention is within the capability of a skilled practitioner in this technical area. Also, all conceivable embodiment variants that are possible by the combination of individual details of the illustrated and described embodiment variant fall within the scope of the invention.

FIG. 3 shows an additional, optionally independent, embodiment of the query-based personal identification method, with the same reference symbols and/or component designations being used again for the same parts, like in the previous FIGS. 1 and 2. To avoid unnecessary repetitions, the detailed description in the preceding figures is incorporated by reference.

Finally, as a matter of form, it should be noted that, in order to better understand the structure of the query-based personal identification method, the method and/or some of its components were not shown to scale and/or enlarged and/or reduced.

The object on which the independent, inventive solutions are based can be found in the description.

Especially the individual illustrated embodiments in FIG. 1 to 3 can form the subject of independent solutions as taught by the invention. The related problems and solutions as taught by the invention can be found in the detailed description of these figures.

### LIST OF REFERENCE SYMBOLS

1 Authentication checking system
2 Detecting device
3 Detection means
4 Communication network
5 Service provision system
6 Authentication system
7 Authentication query
8 Transmission of authentication query
9 Authentication level
10 Alphanumeric input means, keyboard
11 Optical image acquisition device
12 Fingerprint scanner
13 Audiovisual input/output device
14 Reference characteristic
15 Storage means
16 Storage means
17 Release signal
18 Delivery of a release signal
19 Determination of the authentication level
20 Security hierarchy profile
21 Activation of a detection means
22 Detection of a personal identifier
23 Comparison to a reference characteristic
24 Stored reference characteristics
25 Incorrect match
26 Comparison
27 Error signal
28 Authentication control system
29 Communication interface
30 Control commands
31 Execution module

1-22. (canceled)

23. A method for query-based personal identification, comprising the following steps:
receiving an authentication query from an authentication checking system of a service provider system;
ascertaining the required authentication level by the authentication checking system by analyzing the authentication query;
activating a detection feature of a detecting device;
detecting a personal identifier by the detection feature;
comparing the detected identification with a corresponding reference characteristic stored in a memory unit;
when there is a correct match between the detected identification and the corresponding reference characteristic, providing a release signal to the service provider system;
when there is an incorrect match between the detected identification and the corresponding reference characteristic, activating a further detection feature of the detecting device and repeating the respective steps,
wherein a reference characteristic of a personal characteristic is transmitted with the authentication query, and wherein the authentication level is ascertained by comparing the authentication query with a stored security hierarchy profile.

24. The method of claim 23, wherein an error signal in the form of an alarm signal is provided in the event of a repeated, incorrect match.

25. The method of claim 23, wherein a security code number is transmitted with the authentication query which determines the authentication level.

26. The method of claim 25, wherein the security hierarchy profile establishes a correlation between the detection feature and the authentication level.

27. The method of claim 23, wherein a procedural command is transmitted with the authentication query.

28. The method of claim 23, wherein the authentication checking system controls the functionality of the detecting device.

29. The method of claim 23, wherein an alphanumerical identification is detected as a personal identifier.

30. The method of claim 23, wherein a biometric characteristic is detected as a personal identifier.

31. The method of claim 23, wherein an operational action is detected as a personal identifier, which a person to be authenticated uses to operate the detection feature.

32. The method of claim 23, wherein a chronological sequence is captured during the detection of the personal identifier.

33. The method of claim 23, wherein the detection device outputs a personalized inquiry, using an output device and a person's response is detected as a personal identifier.

34. The method of claim 23, wherein the security hierarchy profile is transmitted by an authentication system to the authentication checking system.

35. The method of claim 23, wherein the security hierarchy profile is generated during a training phase, and wherein personal identifiers are detected as reference characteristics and stored in a storage means.

36. The method of claim 35, wherein a deliberate behavior pattern is detected as a personal reference characteristic, and wherein a specific sequence of operational actions on the detection device is detected.

37. The method of claim 35, wherein an unconscious behavior pattern is detected as a personal reference characteristic, in which a person is presented with multiple choices by an input/output device and a respective selection is detected.

38. The method of claim 37, wherein a reaction profile is created from detected selection results.

39. The method of claim 23, wherein reference characteristics are stored in the memory unit of the authentication checking system.

40. The method of claim 23, wherein after a timer sequence, an authentication query is generated on the service provider system or on the authentication checking system.

41. The method of claim 23, wherein an image of a person is detected as the personal identifier.

42. The method of claim 41, wherein the detected image is transmitted to a mobile communication device.
